(19) United States
(12) Patent Application Publication
(10) Pub. No.: US 2009/0203549 A1
(43) Pub. Date: Aug. 13, 2009

(54) FUNCTIONALIZED PLATFORM FOR ARRAYS CONFIGURED FOR OPTICAL DETECTION OF TARGETS AND RELATED ARRAYS, METHODS AND SYSTEMS

(76) Inventor: Paul D. HOEPRICH, JR., Pleasanton, CA (US)

Correspondence Address: LLNL/Steinfl & Bruno;John H. Lee, Assistant Laboratory Counsel, Lawrence Livermore National Laboratory, L-703, P.O. Box 808, Livermore, CA, 94551, US

(21) Appl. No.: 12/366,476

(22) Filed: Feb. 5, 2009

Related U.S. Application Data
(60) Provisional application No. 61/026,982, filed on Feb. 7, 2008.

(51) Int. Cl. C40B 40/08; C40B 50/14; C40B 50/18

(52) U.S. Cl. 506/17; 506/30; 506/32

(57) ABSTRACT

A functionalized platform for a polymer array, comprising a substrate, and a metal oxide layer that attaches a functionalized alkyl phosphonate compound is described together with related array methods and systems.

### CROSS REFERENCE TO RELATED APPLICATIONS

This application claims priority to U.S. Provisional Application entitled “Alkylphosphonate/ITO Functionalized Glass and Plastic Chips as Substrates for Microarray Synthesis” Ser. No. 61/026,982, filed on Feb. 7, 2008 Docket No. IL-11703, the disclosure of which is incorporated herein by reference in its entirety.

### STATEMENT OF GOVERNMENT GRANT

The United States Government has rights in this invention pursuant to Contract No. DE-AC52-07NA27344 between the U.S. Department of Energy and Lawrence Livermore National Security, LLC, for the operation of Lawrence Livermore National Security.

### TECHNICAL FIELD

The present disclosure relates to polymer arrays configured for optical detection of targets, and in particular to a functionalized platform for such polymer arrays, and related arrays methods and systems.

### BACKGROUND

The term polymer array, in particular when used with reference to biological polymer or biopolymers, usually identifies a multiplex technology used in applications such as molecular biology and in medicine to analyze/detect molecular recognition, e.g. hybridization between complementary strands of DNA and other chemical and biological properties associated with molecular recognition between biopolymers of interest.

A polymer array configured for optical detection of targets typically consists of an arrayed series of thousands of microscopic spots of the polymer of interest, called features, each containing a small amount, (e.g. picomoles) of a specific polymer and in particular a biopolymer, (for example a DNA polymer having a specific sequence). Exemplary specific biopolymers include, a short section of a gene or other DNA element that are used as stationary probes capable of binding to added sample molecule (target) under conditions or varying binding stringency. Detection of the target is then typically performed using optically detectable labels, such as fluorescent dyes or fluorescently labeled antibodies that specifically bind the target.

In this connection polymer arrays configured for optical detection of targets are distinct from electrochemical sensors. In electrochemical sensors, for example, the array is arranged on a platform that when in use is connected to an electrode or another source of electrons and target detection is typically performed by electrochemical methods, such as potentiometry or oxidative approaches, where detection of target species is performed by monitoring a change in a subsequently applied current.

In standard, commercially available DNA microarrays configured for optical detection of targets, the features are typically synthesized from a glass surface pre-treated or functionalized with a silane compound terminating in a hydroxyl group to enable in situ chemical synthesis of biopolymers and therefore compatible with DNA synthesis. The solid surface can be glass or a silicon chip, in which case, when the polymer is a biopolymer, the microarrays are also known as bio-chip and when the polymer is DNA, gene chip. Other microarray platforms, such as illumina's microarray products, use microscopic beads, instead of a more planar support.

### SUMMARY

Provided herein, are functionalized platforms for the specific preparation of polymer arrays configured for optical detection of targets, which, in several embodiments, show an improved overall stability and/or detection sensitivity when compared to other polymer arrays of the art.

According to a first aspect, a functionalized platform is described, that comprises a substrate and a metal oxide layer. In the platform, the substrate is coated with the metal oxide layer and the metal oxide layer attaches an alkyl phosphonate compound presenting an alkyl phosphonate functional group. The platform is also configured to be associated, during operation, with a polymer array, and the polymer array is configured for detection of a target attached to a polymer on the polymer array, through an optically detectable label attached to the target.

According to a second aspect, a polymer array is described that is configured to allow detection of a target attached to the polymer through an optically detectable label attached to the target. The polymer array comprises a polymer attached to a functionalized platform described herein wherein the polymer is attached to the alkyl phosphonate functional group of the platform.

According to a third aspect, a bio-chip comprising a polymer array herein described.

According to a fourth aspect, a system for optical detection of a target is described, that comprises a polymer array herein described, and an optically detectable label.

According to a fifth aspect, a method to provide a polymer array is described, that comprises: providing a platform herein described; and attaching a polymer to the alkyl phosphonate functional group of the platform, thus providing the polymer array. In particular, attaching the polymer can be performed by binding a pre-synthesized polymer to the alkyl phosphonate functional group, or by contacting monomers composing the polymer with the platform for a time and under conditions to allow synthesis of the polymer on the platform.

The platforms, arrays, methods and systems herein described allow in several embodiments consistency in the preparation (de novo synthesis) and/or overall chemical stability of the arrays.

Furthermore, the platforms, arrays, methods and systems herein described allow in several embodiments to minimize the loss of arrays material during use of and to minimize occurrence of inconsistent results.

The platforms, arrays, methods and systems herein described also allow in several embodiments to perform optical detection of a target bound to the platform with an increased signal to noise ratio when compared to detection performed with certain arrays known in the art.

Additionally, the platforms, arrays, methods and systems herein disclosed allow in several embodiments, reproducibility of the results and in particular the ability to observe the same result with the same sample, either in the same laboratory or in a different location even in massively parallel experimentation.

The platforms, arrays, methods and systems herein described allow in several embodiments to reliable reuse of the array for example in additional reactions and experimentation involving the same or different test probe sets.

Additionally, the platforms, arrays, methods and systems herein described provide in several embodiments a robust enhancement to glass or plastic chips of the art and related method to manufacture them.

The platforms, arrays, methods and systems herein described can be used in connection with applications wherein detection and/or analysis of a molecule through an array is desired, including but not limited to medical application, biological analysis and diagnostics including but not limited to clinical applications.

The details of one or more embodiments of the disclosure are set forth in the accompanying drawings and the description below. Other features, objects, and advantages will be apparent from the description and drawings, and from the claims.

### BRIEF DESCRIPTION OF THE DRAWINGS

The accompanying drawings, which are incorporated into and constitute a part of this specification, illustrate one or more embodiments of the present disclosure and, together with the detailed description and examples sections, serve to explain the principles and implementations of the disclosure.

FIG. 1 shows a schematic illustration of a functionalized platform according to an embodiment of the present disclosure.

FIG. 2 shows a schematic illustration of the basic coupling chemistry between phosphonate (phosphonic acid) and a metal oxide coated surface according to some embodiments herein disclosed.

FIG. 3 shows a comparative illustration of Atomic Force Microscopic (AFM) images of a platform coated with metal oxide according to an embodiment herein described and a glass platform coated with silane known in the art. Panel A shows an AFM image of a glass coated with a 200 Å ITO layer. Panel B shows an AFM image of a glass coated with a 400 Å ITO layer. Panel C shows an AFM image of a glass coated with a silane layer. The black portions indicate actual glass substrate portions, i.e. regions that are uncoated with silane

FIG. 4 shows a schematic illustration of an array arrangement on a platform according to some embodiments herein described.

FIG. 5 shows a comparative illustration of oligonucleotide spotting on a glass surface coated with an alkyl phosphonate compound terminated with an alkyl phosphonate functional group according to an embodiment herein disclosed (Panel B) and a glass surface coated with γ-aminopropylsilane (Panel A), and phosphates terminated by a methyl group (Panel C).

FIG. 6 shows a comparative illustration of oligonucleotide spotting on a glass surface coated with an alkyl phosphonate compound terminated with an alkyl phosphonate functional group according to an embodiment herein disclosed (Panel B) and a glass surface coated with epoxy-terminated silane (Panel A), and phosphonates terminating with hydroxyl group (Panel C).

FIG. 7 shows a comparative illustration of oligonucleotide spotting on a glass surface coated with an alkyl phosphonate compound terminated with an alkyl phosphonate functional group according to an embodiment herein disclosed (Panel B) and a glass surface coated with epoxy-terminated silane (Panel A), and phosphonates terminating with a methyl group (Panel C).

FIG. 8 shows two exemplary DNA microarrays synthesized on an ITO/undecylhydroxy functionalized platform according to an embodiment herein disclosed. Fiducial markers are readily apparent enabling the microarray to be scanned. The sample on the right contains a version of a whole human genome array.

FIG. 9 shows a histogram representative of the fluorescent intensity of bound fluorophore to a human genome microarray according to an embodiment herein disclosed. Values on the Y axis represent features or feature frequency and values on the X-axis represent over all fluorescent signal.

FIG. 10 shows a histogram taken from a known silane-derivatives glass slide comprising microarrays synthesized using MAS technology. Values on the Y axis represent features or feature frequency and values on the X-axis represent over all fluorescent signal.

### DETAILED DESCRIPTION

Functionalized platforms, are described that can be used to provide polymer arrays configured for optical detection of targets.

The term “platform” as used herein indicates a physical and usually flat structure suitable for carrying a polymer array. A platform typically comprises a substrate functionalized to be capable of reacting with a polymer of the polymer array and the polymer array.

The term “substrate” as used herein indicates a base material on which processing can be conducted to modify the chemical nature of at least one surface of the base material. Exemplary chemical modifications include functionalization and/or depositing on the modified surface a layer of a second material chemically different from the base material. Exemplary substrates in the sense of the present disclosure include but are not limited to glass, such as silica-based glass, plastics, such as cyclo-olefin copolymer, carbonates and the like, and silicon materials, such as the ones used in the electronic industry.

The terms “functionalize” and “functionalization” as used herein, indicates the appropriate chemical modifications of a molecular structure (including a substrate or a compound) resulting in attachment of a functional group to the molecular structure. The term “functional group” as used herein indicates specific groups of atoms within a molecular structure that are responsible for the characteristic chemical reactions of that structure. Exemplary functional groups include, hydrocarbons, groups containing halogen, groups containing oxygen, groups containing nitrogen and groups containing phosphorus and sulfur all identifiable by a skilled person.

In platforms for polymer arrays, the substrate is typically chemically modified to attach one or more functional groups. The term “attach” or “attached” as used herein, refers to connecting or uniting by a bond, link, force or tie in order to keep two or more components together, which encompasses either direct or indirect attachment such that for example where a first compound is directly bound to a second compound or material, and the embodiments wherein one or more intermediate compounds, and in particular molecules, are disposed between the first compound and the second compound or material.

In particular, in polymer arrays selected functional groups that are able to react, with a polymer of choice that forms the polymer arrays, are attached to the functionalized substrate surface so that they are presented on the surface. The term “present” as used herein with reference to a compound or functional group indicates attachment performed to maintain the chemical reactivity of the compound or functional group as attached. Accordingly, a functional group presented on a surface, is able to perform under the appropriate conditions the one or more chemical reactions that chemically characterize the functional group.

In polymer arrays herein disclosed, functional groups are presented on the platform so that, upon contact with the appropriate polymer, those functional groups can bind the polymer thereby attaching the polymer to the platform. Exemplary functional groups suitable in polymer arrays include hydrocarbons, groups containing nitrogen, such as amines, amides nitrites or nitrates, and group containing oxygen such as, carboxyl, epoxyl, hydroxyl or ester groups. In several embodiments, those groups facilitate both recognition and binding of polymer probes.

The term “polymer” as used herein indicates a large molecule (macromolecule) composed of repeating structural units typically connected by covalent chemical bonds. Polymers constitute a large class of natural and synthetic materials with a variety of properties and purposes and include bio-polymers which are the typical polymer component of polymer arrays as identified herewith. Biopolymers comprise polysaccharides polymers made up of many monosaccharides joined together by glycosidic bonds), polynucleotide and polypeptides that are originally produced by a living organism including viruses.

The term “polynucleotide” as used herein indicates an organic polymer composed of two or more monomers including nucleotides, nucleosides or analogs thereof. The term “nucleotide” refers to any of several compounds that consist of a ribose or deoxyribose sugar joined to a purine or pyrimidine base and to a phosphate group and that is the basic structural units of nucleic acids. The term “nucleoside” refers to a compound (as guanosine or adenosine) that consists of a purine or pyrimidine base combined with deoxyribose or ribose and is found especially in nucleic acids. The term “nucleotide analog” or “nucleoside analog” refers respectively to a nucleotide or nucleoside in which one or more individual atoms have been replaced with a different atom or a with a different functional group. Accordingly, the term polynucleotide includes nucleic acids of any length including DNA, RNA, DNA or RNA analogs and fragments thereof. A polynucleotide of three or more nucleotides is also called nucleotidic oligomers or oligonucleotide. Exemplary polynucleotides composing arrays herein disclosed are DNA molecules, and in particular DNA oligomers, peptide nucleic acids (PNAs), locked nucleic acid polymers (LNAs) and the like.

The term “peptide nucleic acid” indicates an artificially synthesized polymer similar to DNA or RNA and is used in biological research and medical treatments. PNA is not known to occur naturally. In particular, while DNA and RNA have a deoxyribose and ribose sugar backbone, respectively, whereas PNA's backbone is composed of repeating N-(2-aminoethyl)-glycine units linked by peptide bonds. The various purine and pyrimidine bases are linked to the backbone by methylene carbonyl bonds. PNAs are depicted like peptides, with the N-terminus at the first (left) position and the C-terminus at the right.

The term “locked nucleic acid”, often referred to as inaccessible RNA, indicates a modified RNA nucleotide. The ribose moiety of an LNA nucleotide is modified with an extra bridge connecting the 2′ and 4′ carbons. The bridge “locks” the ribose in the 3′-endo structural conformation, which is often found in the A-form of DNA or RNA. LNA nucleotides can be mixed with DNA or RNA bases in the oligonucleotide whenever desired. Such oligomers are commercially available. The locked ribose conformation enhances base stacking and backbone pre-organization. This significantly increases the thermal stability (melting temperature) of oligonucleotides. LNA nucleotides are used to increase the sensitivity and specificity of expression in DNA microarrays, FISH probes, real-time PCR probes and other molecular biology techniques based on oligonucleotides. For the in situ detection of miRNA the use of LNA is currently (2005) the only efficient method. A triplet of LNA nucleotides surrounding a single-base mismatch site maximizes LNA probe specificity unless the probe contains the guanine base of G-T mismatch.

The term “polypeptide” as used herein indicates an organic polymer composed of two or more amino acid monomers and/or analogs thereof. The term “polypeptide” includes amino acid polymers of any length including full length proteins and peptides, as well as analogs and fragments thereof. A polypeptide of three or more amino acids is also called a protein oligomer or oligopeptide. As used herein the term “amino acid”, “amino acidic monomer”, or “amino acid residue” refers to any of the twenty naturally occurring amino acids including synthetic amino acids with unnatural side chains and including both D and L optical isomers. The term “amino acid analog” refers to an amino acid in which one or more individual atoms have been replaced, either with a different atom, isotope, or with a different functional group but is otherwise identical to its natural amino acid analog.

The term “protein” as used herein indicates a polypeptide with a particular secondary and tertiary structure that can participate in, but not limited to, interactions with other biomolecules including other proteins, DNA, RNA, lipids, metabolites, hormones, chemokines, and small molecules. Exemplary proteins composing arrays herein described are antibodies.

The term “antibody” as used herein refers to a protein that is produced by activated B cells after stimulation by an antigen and binds specifically to the antigen promoting an immune response in biological systems and that typically consists of four subunits including two heavy chains and two light chains. The term antibody includes natural and synthetic antibodies, including but not limited to monoclonal antibodies, polyclonal antibodies or fragments thereof. Exemplary antibodies include IgA, IgD, IgG1, IgG2, IgG3, IgM and the like. Exemplary fragments include Fab Fv, Fab′ F(ab′)2 and the like. A monoclonal antibody is an antibody that specifically binds to and is thereby defined as complementary to a single particular spatial and polar organization of another biomolecule which is termed an “epitope”. A polyclonal antibody refers to a mixture of monoclonal antibodies with each monoclonal antibody binding to a different antigenic epitope. Antibodies can be prepared by techniques that are well known in the art, such as immunization of a host and collection of sera (polyclonal) or by preparing continuous hybridoma cell lines and collecting the secreted protein (monoclonal).

The term “array” as used herein indicates a regular and imposing grouping or arrangement of molecules, and in particular polymers, immobilized on an appropriate or compatible substrate in an ordered manner. More particularly, the term array indicates an ordered grouping of polymers arranged so to allow, under appropriate conditions, specific binding of a target to at least one of the polymer composing the polymer array and subsequent optical detection of the target bound to the polymer.

The term “target” as used herein indicates an analyte of interest. The term “analyte” refers to a substance, compound or component whose presence or absence in a sample has to be detected. Analytes include but are not limited to biomolecules and in particular biomarkers. The term “biomolecule” as used herein indicates a substance compound or component associated to a biological environment including but not limited to sugars, aminoacids, peptides proteins, oligonucleotides, polynucleotides, polypeptides, organic molecules, haptens, epitopes, biological cells, parts of biological cells, vitamins, hormones and the like. The term “biomarker” indicates a biomolecule that is associated with a specific state of a biological environment including but not limited to a phase of cellular cycle, health and disease state. The presence, absence, reduction, upregulation of the biomarker is associated with and is indicative of a particular state.

The term “detect” or “detection” as used herein indicates the determination of the existence, presence or fact of a target or signal in a limited portion of space, including but not limited to a sample, a reaction mixture, a molecular complex and a substrate including a platform and an array. A detection is “quantitative” when it refers, relates to, or involves the measurement of quantity or amount of the target or signal (also referred as quantitation), which includes but is not limited to any analysis designed to determine the amounts or proportions of the target or signal. A detection is “qualitative” when it refers, relates to, or involves identification of a quality or kind of the target or signal in terms of relative abundance to another target or signal, which is not quantified. An “optical detection” indicates a detection performed through a visually detectable signal, typically issued by a label attached to the target and providing the labeling signal.

The terms “label” and “labeled molecule” as used herein refer to a molecule capable of detection, including but not limited to radioactive isotopes, fluorophores, chemioluminescent dyes, chromophores, enzymes, enzymes substrates, enzyme cofactors, enzyme inhibitors, dyes, metal ions, nanoparticles, metal sols, ligands (such as biotin, avidin, streptavidin or haptens) and the like. The term “fluorophore” refers to a substance or a portion thereof which is capable of exhibiting fluorescence in a detectable image. As a consequence the wording and “labeling signal” as used herein indicates the signal emitted from the label that allows detection of the label, including but not limited to radioactivity, fluorescence, chemolumiescence, production of a compound in outcome of an enzymatic reaction and the likes. A “visually detectable signal” indicates a signal that is visible and/or detectable through the use of visual aids, (e.g. a standard commercially available fluorescence reader.)

In platform herein described a substrate is coated with a functionalized metal oxide layer. The term “layer” as used herein indicates a single thickness of material covering a surface. Accordingly, a metal oxide layer is a thickness of a metal oxide compound covering a substrate surface of the substrate of the platform or a portion thereof. Suitable substrates include glass or plastics such as polycarbonate or cyclo-olefin co-polymer (COP) making transparent plastic of high optical quality.

The term “metal oxide” as used herein indicates a compound including at least one oxygen atom bound to a metal atom. Exemplary metal oxides include in particular amphoteric metal oxide such as aluminum oxide and other metal oxides wherein the metal element is in a +3 oxidation state, tin oxide other metal oxides wherein the metal element is in a +4 oxidation state or mixture thereof.

In platform herein disclosed, a metal oxide thickness can be applied to the substrate by deposition of the metal oxide performed by techniques identifiable by a skilled person. In particular, in several embodiments herein disclosed, a substrate of the surface is coated by the metal oxide, wherein the term “coat” and “coating” indicates a covering of the metal oxide applied to the surface using techniques known in the art. Exemplary techniques suitable to apply a coating to a substrate include chemical vapor deposition, conversion coating, plating and other techniques identifiable by a skilled person.

In preferred embodiments, the metal oxide is Indium Tin Oxide (ITO), a solid solution of indium (III) oxide (In₂O₃) and tin(IV) oxide (SnO₂), typically 90% In₂O₃, 10% SnO₂ by weight. ITO is usually found solid state, has a melting point of 1800-2200 K (2800-3500° F.), and a density of 7120-7160 kg/m³ at 293 K. In thin layers ITO is usually transparent and colorless. In bulk form, ITO shows a pale yellow to greenish yellow, depending on SnO₂ concentration. In the infrared region of the spectrum it is a metal-like mirror. Indium tin oxide's main feature is the combination of electrical conductivity and optical transparency. However, a compromise has to be reached during film deposition, as high concentration of charge carriers will increase the material's conductivity, but decrease its transparency. Thin films of indium tin oxide are most commonly deposited on surfaces by electron beam evaporation, physical vapor deposition, or a range of sputter deposition techniques.

In some embodiments, the metal oxide and in particular the ITO is applied to a substrate that is two-dimensional, such as a typical glass microscope slide of standard dimension, i.e. 25 mm×75 mm. Other substrate materials might include but not limited to glass and in particular silica glasses, plastic materials, e.g. cyclo-olefin copolymer, carbonates and the like, as well as quartz and conventional silicon-based chip material.

In platforms and array herein disclosed, the metal oxide is functionalized with a alkyl phosphonate compound that presents an alkyl phosphonate functional group. In particular, in some embodiments, the metal oxide layer is treated with a solution of a functionalized alkyl phosphonate compound. In those embodiments, the phosphonates form an ordered monolayer on the ITO surface and are covalently linked to the ITO via formation of stable metal-phosphodiester bonds as has been well-established in published scientific literature.

In certain embodiments the alkyl phosphate compound can comprise a phosphonate reactive with metal oxides, attached to the metal oxide layer in an irreversible manner and designed and synthesized to containing specific and reactive chemical functional groups able to react with one or more polymers of choice. More particularly, in certain embodiments, the alkyl phosphonate functional group attached to the metal oxide layer is a terminal/accessible reactive chemical functional group, for example but not limited to hydroxyl, amino, phosphonic acid and the like.

Exemplary alkyl phosphonate compounds in the sense of the present disclosure comprise organic compounds containing one or more unit having formula (I) XR₁—PO(OR₂R₃)₂ wherein X=functional group, R₁=alkyl side chain and R₂ and R₃ are H.

The term “alkyl side chain” indicates carbon and hydrogen atoms, arranged in a chain. The alkyl refers to a series with the general formula CₙH₂ₙ₊₁. They include methyl, CH₃. (named after methane), ethyl (C₂H₅.), propyl (C₃H₇.), butyl (C₄H₉.), pentyl (C₅H₁₁.), and so on. In some embodiments, R₁ is a lower alkyl, i.e. an alkyl group having

In some embodiments, the alkyl group is a lower alkyl group and more specifically a C₁-C₂₀ alkyl group, a C₁-C₁₀ alkyl group or a C₁-C₅ alkyl group.

In some embodiments, the phosphonate compound can be Aminoethylphosphonic acid, Dimethyl methylphosphonate, 1-Hydroxyethane(1,1-diylbisphosphonic acid), Nitrilotris(methylenephosphonic acid), 1,2-Diaminoethanetetrakis (methylenephosphonic acid), Diethylenetriaminepentakis (methylenephosphonic acid) and Phosphonobutane-tricarboxylic acid.

In some embodiments, the alkyl phosphonate functional group can be a hydrocarbon such as methyl group. In some embodiments the alkyl phosphonate functional group can be a group containing nitrogen such as an amine. The alkyl phosphonate functional group can be a group containing oxygen such as a carboxyl or a hydroxyl group. In some embodiments, the alkyl phosphonate functional group can be a group containing phosphorus such as a phosphoric acid. In particular, in a preferred embodiment the alkyl phosphonate functional group can be alkyl (C₁₁) phosphonates containing an —OH functional group.

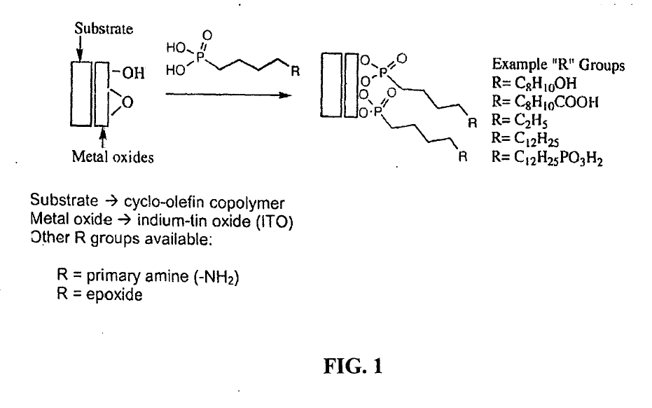

FIG. 1 shows a schematic illustration of a functionalized platform according to an embodiment of the present disclosure showing a substrate coated with a metal oxide functionalized with a functionalized alkyl phosphonate compound. In the representation of FIG. 1, additional exemplary alkyl phosphonate functional groups are indicated as substituent R of the phosphonate depicted therein.

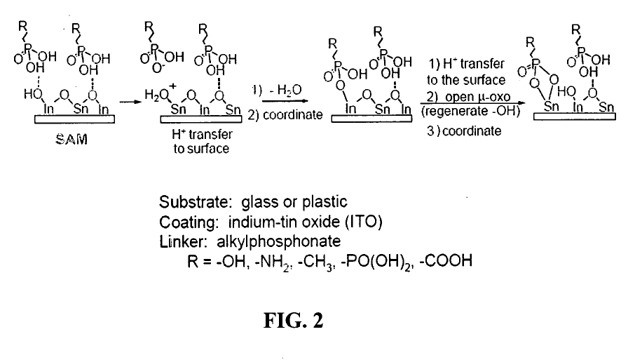

FIG. 2 shows a schematic illustration of the basic coupling chemistry between phosphonate (phosphonic acid) and an indium-tin oxide (ITO) coated surface. Alkyl side chains are indicated terminating with a variety of functional groups.

In particular in some embodiments, plastic substrates are coated with an ITO layer that will facilitate deposition of a phosphonate-base and more particularly of a Self Assembling Monolayer (SAM) of a functionalized alkyl phosphonate compound. Suitable techniques for coating the substrate are identifiable by a skilled person upon reading of the present disclosure and include but are not limited to the techniques described in T. Gardner et al JACS 1995, 117:6927-6933.

In some embodiments, functionalized platforms are described that allow functionalization of a substrate with a polymer that result in a particularly stable surface.

The term “stable” and “stability” as used herein indicate chemical linkage to the substrate surface via the coating and functionalization chemistry, e.g. between a phosphonate and ITO, that is not readily altering in chemical makeup or physical state of the surface. In particular, it is expected that in certain embodiments, metal-phosphodiester bonds are stable to non-specific bond cleavage by aqueous buffer solutions unlike their silane-based counterparts used throughout microarray methodology.

In some embodiments, the stability of the metal-phosphodiester bond is expected to allow microarrays to be re-used multiple times since this bond is not subject to hydrolysis commonly associated with silanes. Additionally, using this robust and stable chemical paradigm is expected to greatly facilitate reproducible chemistry, i.e. consistent preparation of substrates for array synthesis that will enable application into future markets such as diagnostic, clinical and otherwise, where stability and reproducibility are paramount.

In embodiments herein disclosed the platform can be developed for the purpose of preparation of arrays and in particular microarrays of bio-polymers or biopolymeric materials as defined above and in particular DNA, RNA, peptides, carbohydrates and analogs thereof such as PNAs, LNAs and the like. In particular, in some embodiments the polymer is a polynucleotide (and in particular DNA) of less than 100 nucleotide bases in length.

In particular, in some embodiments, the arrays herein disclose are based on a stable surface functionalization that preparation of biopolymer-based microarrays on both glass and plastic surfaces, including but not limited to co-polymer cyclo-olefin materials and silica. In particular in some embodiments, a method is provided wherein glass or plastic substrate coated with ITO and then treated with an alkyl phosphonate compound forming a stable phosphodiester with the metal oxide; the alkyl chain bearing a functional chemical group enables further chemical elaboration, e.g. DNA synthesis that results in a population of several thousand DNA probe structures

In some of those embodiments, the basic substrate surface is a material that presents a two-dimensional surface suitable for the planar display of a reactive probe set, e.g. single-strand DNA. The substrate can be coated, using a chemical vapor deposition process with a ITO layer of any thickness. In some embodiments, the thickness of the ITO layer can be 100 and 1,500 angstrom and in particular between 200 and 400 angstroms. The ITO coating can then be treated/cleaned and then reacted immediately with phosphonate moieties containing reactive side-chain groups, e.g. hydroxyl. At least in some embodiments, the latter treatment results, expectedly and reportedly, in a monolayer-type arrangement of the alkylphosphonate molecules on the ITO surface (see Example 1).

In some embodiments, attachments of the polymer to the substrate coated with metal oxide can be achieved by spotting a molecule in a give location on the two-dimensional surface or by coordinated, site-specific de novo chemical synthesis of molecules on the same substrate surface.

In particular, some embodiments, the substrate coated with metal oxide can be contacted with polymers prepared by direct chemical synthesis of the polymer involving sequential addition of monomeric units, such as nucleotides in the exemplary embodiments where the polymers are DNA probes. In particular, in some embodiments individual protected monomeric nucleic acids are added in a defined order to produce a polymer, for example a single strand of DNA, covalently attached to the metal oxide layer on the substrate surface, according to techniques known to the skilled person. Exemplary techniques suitable for performing polymer synthesis include but are not limited to those described in G H McGall et al. “The Efficiency of Light-Directed Synthesis of DNA Arrays on Glass Substrates” J. Amer. Che. Soc. 1997, 119:5081-5090. A skilled person will be able to identify other techniques that are suitable for synthesizing polymers on a substrate and to apply those techniques to the platform herein described. In some of those embodiments, where the alkyl phosphonate compound in the metal oxide layer was a phosphoric acid terminated alkylphosphonate binding and retention of maximal polymer amounts was observed.

In other embodiments, the substrate coated with metal oxide can then be spotted and in particular robotically spotted with pre-synthesized polymers, such as DNA. Techniques suitable for spotting polymers on the substrate of an array are known to a skilled person. For example, spotting of the polymer on the platform can be performed using the techniques described in M A Schena et al. “Quantitative Monitoring of Gen Expression Patterns with a Complementary DNA Microarray” Science, 1995, 270:467-470. Additional techniques suitable for spotting polymers on a substrate are identifiable by a skilled person and will not be further discussed herein in detail.

In several embodiments, the stability of the chemical bond between phosphonate and ITO will provide microarrays of enhanced chemical robustness and amenable to being re-used, i.e. using an array more than one. In particular, surface functionalization of the ITO layer with an alky phosphonate hydroxy-linker, e.g. hydroxyl-undecylphosphonate, provides a starting point for DNA synthesis which results in a population of several thousand DNA probe structures. Additionally, these same functionalized surfaces (glass and plastic) can receive directly sample of pre-synthesized DNA oligomer molecules that are individually “spotted” on the surface. In both cases, further processing of arrays with sample DNA or RNA is routine as practiced in the art providing useful information about gene expression, genetic analysis and gene-based identification.

In some embodiments, ITO/phosphonate functionalized slides can be further elaborated to facilitate preparation of other biopolymers in a microarray format. Examples of other biopolymers include but are not limited to: aptamers, RNA, PNA, LNA, DNA thiophospates, peptides, proteins, peptidomimetics and the like.

In some embodiments, a polymer array is then formed that is configured to allow detection of a target attached to the polymer through an optically detectable label attached to the target.

In those biopolymer arrays probe-target hybridization is usually detected and quantified by fluorescence-based detection of fluorophore-labeled targets to determine relative abundance of nucleic acid sequences in the target.

Arrays include but are not limited to: features ranging in size from 25 square microns (μ²) to 250 square microns (μ²) that are made by mechanically (robotically) or manually spotting a defined volume of polymer on the substrate surface.

Microarrays include but are not limited to features ranging in size from 5 square microns (μ²) to 250 square microns (μ²) that are prepared by de novo synthesis of a plurality of defined biopolymer material, e.g. DNA probes; using established solid phase synthetic chemistry.

In some embodiments, the surface is on a “chip” and in particular “biochip” (when the polymer is a bio-polymer) where the term “chip” indicates a collection of miniaturized test sites (microarrays) arranged on a solid substrate that permits many tests to be performed at the same time in order to achieve higher output and speed. Biochips can also be used to perform techniques such as electrophoresis or PCR using microfluidics technology.

In some embodiments the chip is roughly 1″×3″ (25 mm×75 mm), or the size of a microscope slide and is a glass microscope slide or plastic material, e.g. cyclo-olefin copolymer (COP). These materials can be coated with ITO of varying thicknesses (e.g. 100-1,500 angstrom) and further reacted with one of a family of alky phosphonate compounds, some bearing a functional chemical group enabling further chemical elaboration.

In some embodiments, the arrays herein disclosed can be formed in glass chips that contain thousands of DNA sequence allowing access to many genes at once. Microarray applications such as Genome arrays (more particularly comparative Genome Hybridization and Comparative Genome re-sequencing suitable for evolutionary Genomics disease research e.g. cancer) and Expression arrays (more particularly transcription arrays and proteome arrays suitable for host pathogen interactions disease pathogenesis and diagnostics) and Small molecule arrays (e.g. small affinity ligands peptides, serum components suitable for drug testing pharmacogenomics).

More particularly the gene expression microarrays analyze the genetic expression in comparison to uncover the biomarkers of disease progression. It can be performed using both commercial and custom designed microarrays.

In some embodiments a platform is provided that is a bond self-assembled, compact organophosphate monolayers to oxide surfaces. The coating is achieved through self assembly of phosphonate groups. The phosphonate films have a coating achieved through self-assembly of phosphonate groups. The strength derives from the phosphonate di-ester bond. Two (or three, depending on isomerization) covalent bonds prevent loss of coating. Additionally slides composed of phosphonate films are easy to functionalize include a more comprehensive coverage, are more stable and are corrosion resistant.

After the phosphonate group and the alkyl chain: R group can be changed to achieve various properties such as conductivity, dielectric, thickness, chemical and thermal stability. Reference is made to the schematics of FIGS. 1 and 2 wherein the R group at the end of the alkyl chain is amine, hydroxyl, methyl, or phosphonic acid.

In several embodiments, use of ITO/phosphonate functionalized slides is foreseen to facilitate preparation of other biopolymers (e.g. aptamers, RNA, PNA, LNA, DNA thiophosphonates, peptides, proteins, peptidomimetics, and the like) in a microarray format.

In several embodiments, the array herein described the arrays herein described show an enhanced probe retention leading to improved overall stability and/or chemical robustness to the extent of allowing, in certain embodiments, reuse of the microarray.

In several embodiments, the arrays herein described allow performance of target detection with a greater sensitivity when compared to other platform of the art.

In some embodiments the arrays, alone or comprised in a chip, are comprised in a system for optical detection of a target, together with an optically detectable label.

In some embodiments, the optically detectable label is attached to a capture agent. The wording “capture agents” as used herein indicate a molecule capable of specific binding with a predetermined target to form a detectable capture agent target complex.

The wording “specific” “specifically” or specificity” as used herein with reference to the binding of a molecule to another refers to the recognition, contact and formation of a stable complex between the molecule and the another, together with substantially less to no recognition, contact and formation of a stable complex between each of the molecule and the another with other molecules. Exemplary specific bindings are antibody-antigen interaction, cellular receptor-ligand interactions, polynucleotide hybridization, enzyme substrate interactions etc. The term “specific” as used herein with reference to a molecular component of a complex, refers to the unique association of that component to the specific complex which the component is part of. The term “specific” as used herein with reference to a sequence of a polynucleotide refers to the unique association of

Exemplary capture agents include but are not limited to polynucleotides and proteins, and in particular antibodies.

In some embodiments, the devices, arrays, methods and systems herein disclosed can be associated with a microfluidic component so to allow performance of microfluidic based assays. Microfluidic-based assays offer advantages such as reduced sample and reagent volumes, and shortened assay times.

The term “microfluidic” as used herein refers to a component or system that has microfluidic features, e.g., channels and/or chambers that are generally fabricated in the micron or sub-micron scale. For example, the typical channels or chambers have at least one cross-sectional dimension in the range of about 0.1 microns to about 1500 microns, more typically in the range of about 0.2 microns to about 1000 microns, still more typically in the range of about 0.4 microns to about 500 microns. Individual microfluidic features typically hold very small quantities of fluid, e.g. from about 10 nanoliters to about 5 milliliters, more typically from about 100 nanoliters to about 2 milliliters, still more typically from about 200 nanoliters to about 500 microliters, or yet more typically from about 500 nanoliters to about 200 microliters.

The microfluidic components can be included in an integrated device. As used herein, “integrated device” refers to a device having two (or more) components physically and operably joined together. The components may be (fully or partially) fabricated separate from each other and joined after their (full or partial) fabrication, or the integrated device may be fabricated including the distinct components in the integrated device. An integrated microfluidic device includes a microfiltration component joined to a microfluidic component, wherein the microfiltration component and the microfluidic component are in operable association with each other such that the microfiltration component is in fluid communication with a microfluidic feature of the microfluidic component. A microfluidic component is a component that includes a microfluidic feature and is adapted to being in operable association with an microfiltration component. A microfiltration component is a component that includes a microfiltration device, array or system and is adapted to being in operable association with a microfluidic component.

The microfluidic systems can also be provided in a modular form. The term “modular” describes a system or device having multiple standardized components for use together, wherein one of multiple different examples of a type of component may be substituted for another of the same type of component to alter the function or capabilities of the system or device; in such a system or device, each of the standardized components being a “module”.

### EXAMPLES

The platforms, arrays, methods and systems herein disclosed are further illustrated in the following examples, which are provided by way of illustration and are not intended to be limiting.

Surface chemistry matters: robust microarray preparation and analysis requires high quality glass and/or plastic surfaces. ITO-coated ω-hydroxy-alkylphosphonate coated slides provided significant advantages as exemplified below:

### Example 1

### Comparative Evaluation of Surface Chemistry

Three commercially available slides, each functionalized with the following chemical functional groups were used for robotic printing of a microarray: Amino (GAPS Slides, (Corning), Epoxy (Telechem International), and functionalized Phosphonate.

The Gamma aminopropyl silane, the GAPS series by Corning, is functionalized with covalent attachment between the silane and surface Si—OH groups on the glass surface. The epoxy slides are functionalized with the epoxy functional group, with dual covalent linkages between epoxy group and glass surface Si—OH groups.

The phosphonate functionalized slides were prepared by reacting various phosphonates with an ITO coated glass slide prepared according to defined parameters. In particular, ITO slides were prepared by chemical vapor deposition, and the thickness of the ITO ranged from 100 A to 1500 A. The slides were then coated with 100 uM solution of phosphonate dissolved in absolute ethyl alcohol (EtOH), incubation for less than 1 hour. The slides were washed three times in EtOH with sonication at 5 min, dried in vacuo and stored in desiccator. This process can be performed for each functionalized alkyl phosphonate.

In the exemplary experiments illustrated herein, the phosphonate was functionalized with the following alkylphosphonates functional groups: hydroxyl-terminated; methyl-terminated; and phosphonic acid-terminated (Aculon Corporation). In particular, the slide was coated with Indium Tin Oxide (ITO) using established vapor deposition processes. The ITO coating was then be treated/cleaned (e.g. with a plasma (ozone)) for 10 minutes and then reacted immediately with phosphonate moieties containing the appropriate reactive side-chain groups (vide supra).

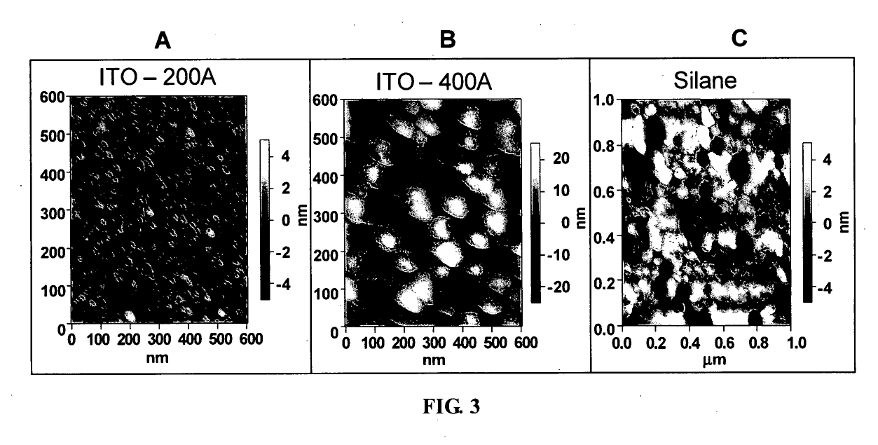

The phosphonates did form an ordered monolayer on the ITO surface and are covalently linked to the ITO via formation of stable metal-phosphodiester bonds as has been well-established in published scientific literature, as shown in FIG. 3.

In particular, FIG. 3, shows an AFM image analysis of an ITO coated substrate (Panels A and B) compared with a silane coated substrate (Panel C). The images of FIG. 3 indicate that ITO layers, irrespective of thickness, i.e. 200 A or 400A are more uniform that the silane coated surface. Note: the black spaces are the actual glass substrate, i.e. regions that are uncoated with silane. FIG. 3 shows atomic force microscopic images of ITO coating and silane coating on glass. ITO, irrespective of thickness, i.e. 200 A or 400 A is more uniform that the silane coated surface. Additional measurements showed no difference between ITO before and after treatment with phosphonate (data not shown).

To test the affinity of respective functional surface chemistries, each of these slides were spotted or printed with DNA oligomers representing Franciscella tularensis open reading frames or ORFs. The spots were printed in duplicates together with controls.

In particular, the GAPS coated glass slides were printed by covalently attaching the DNA oligomers and non-specific attachment (electrostatic association) of the oligomers. The epoxy slides (epoxy functional group) are associated to the dual covalent linkages between the epoxy group and glass surface Si—OH groups and between the epoxy group and the DNA oligomer. The functionalized phosphonate slides were printed by robotic spotting of the DNA oligomer to the slide (vide infra).

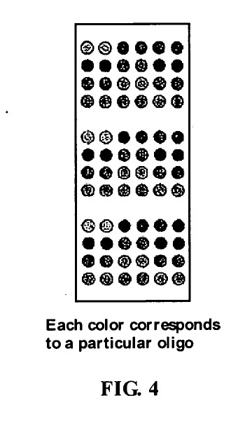

Each slide was printed so that three independent arrays on each slide according to an arrangement such as the one illustrated in FIG. 4.

In particular, the slides were printed using a Genomic Solutions Omnigrid Accent Benchtop Microarrayer having the following features: ultra high-speed—10,000 spots per slide on 50 slides in 2.5 hrs with 48 pins. As mentioned before, the slides were printed in duplicates as an extra control, to ensure greater confidence in results. The equipment comprises enclosed chamber to control moisture.

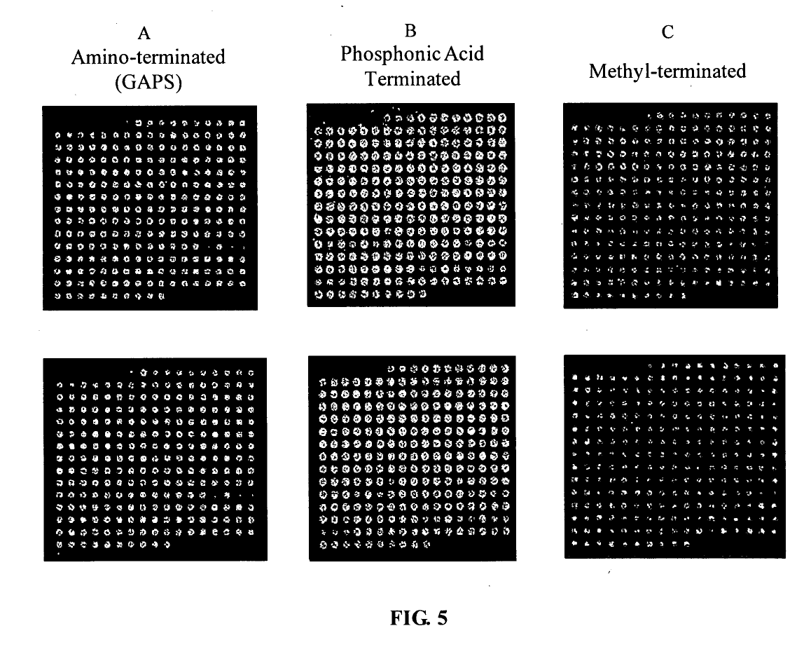

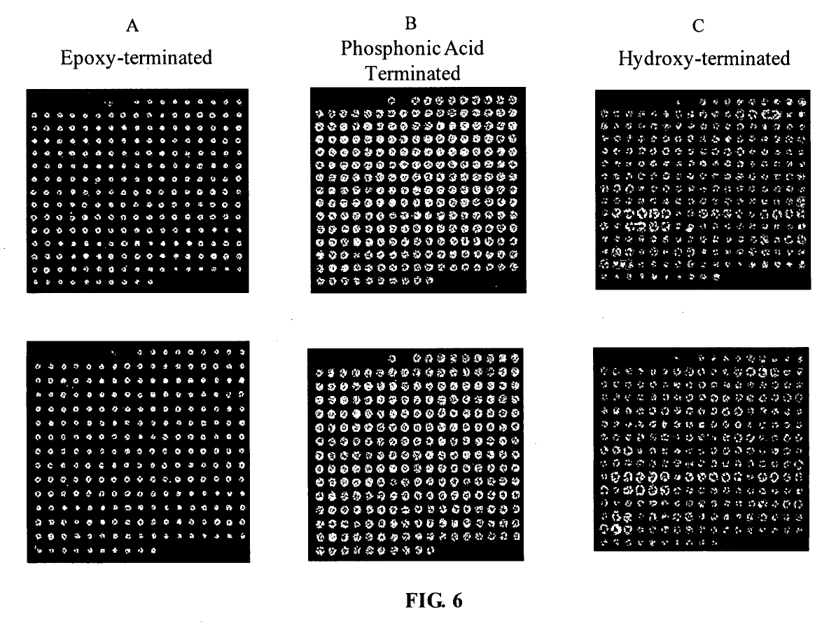

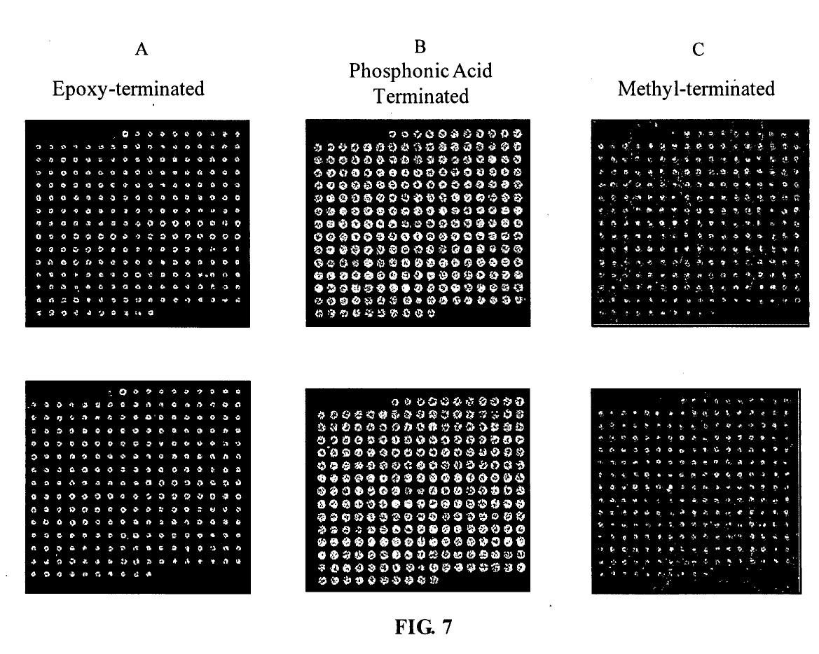

The results illustrated in exemplary FIGS. 5, 6 and 7 show that the ITO-coated slides and both Epoxy and ITO-functionalized slides were superior to GAPS with regard to retaining spotted DNA oligomers.

In particular, the results of FIGS. 5 to 7 ITO-functionalized slides showed spotted DNA oilgomers were retained on the surface irrespective of terminal functional group, i.e. hydroxyl group introduced issues of spot merging and size variation; methyl-terminated slides had consistently high background levels; and finally, phosphonic acid containing slides performed best according to three criteria: 1) All spots are printed; 2) Spots consistent in size and morphology; and 3) Very little merging. Overall, ITO-coated functionalized slides were superior in their ability to retain DNA oligomers when spotted by mechanical robotic methods.

### Example 2

### De novo Synthesis of DNA Probes on hydroxy-phosphonate Functionalized ITO-Coated Slides on a Maskless Array Synthesizer (MAS)

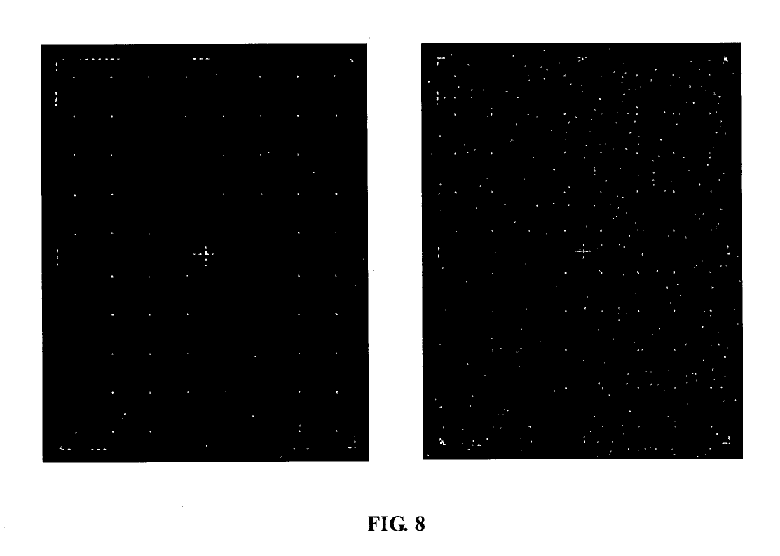

A first application of ITO-coated hydroxy-alkylphosphonate coated slides entailed de novo synthesis of a plurality of DNA oligomers, representing fiducial markers in a pre-defined patterned array, shown in FIG. 8. Automated DNA synthesis was conducted on a Maskless Array Synthesizer from the Nimblegen Corporation, Mdison, Wis. Standard DNA chemistry was used with but with a photolabile protecting group on the ribose 5′-hydroxy group as described in their plenary publication, Nature Biotechnology 1999, 17:974-978.

This approach allowed direct comparison of similar arrays synthesized on an equivalent hydroxyl-silane coated slide.

Both methods yielded the desired DNA microarray with comparable results. The signal measured from the silane containing slides was greater than that measured from the arrays made from ITO-coated hydroxy-alkylphosphonate coated slides.

The Applicant has therefore shown that both deposition of pre-synthesized DNA molecules and DNA that is synthesized in a de novo manner, can be accommodated. The later observation is unprecedented in that a glass substrate can be coated. Using established chemical vapor deposition methods, with a uniform layer of indium-tin oxide. This particular metal oxide can be treated with a solution of alkylphosphonate, in particular ω-hydroxyundecylphosphonate, to provide a surface enabling step-wise DNA synthesis as shown in FIG. 1. Moreover, this surface when made on a glass microscope slide (25 mm×75 mm) is suitable for automated synthesis of DNA-based microarrays using standard protocols of solid-phase DNA synthesis. Additionally, the Applicant has used a Maskless Array Synthesizer (MAS) to demonstrate de novo microarray synthesis and that chemistry relies solely on light-based deprotection vs. traditional acid based deprotection chemistry to reveal a newly reactive —OH nucleophile to continue polymer synthesis.

### Example 3

### Synthesis Performed on hydroxy-phosphonate Functionalized ITO-Coated Slides on a Maskless Array Synthesizer (MAS)

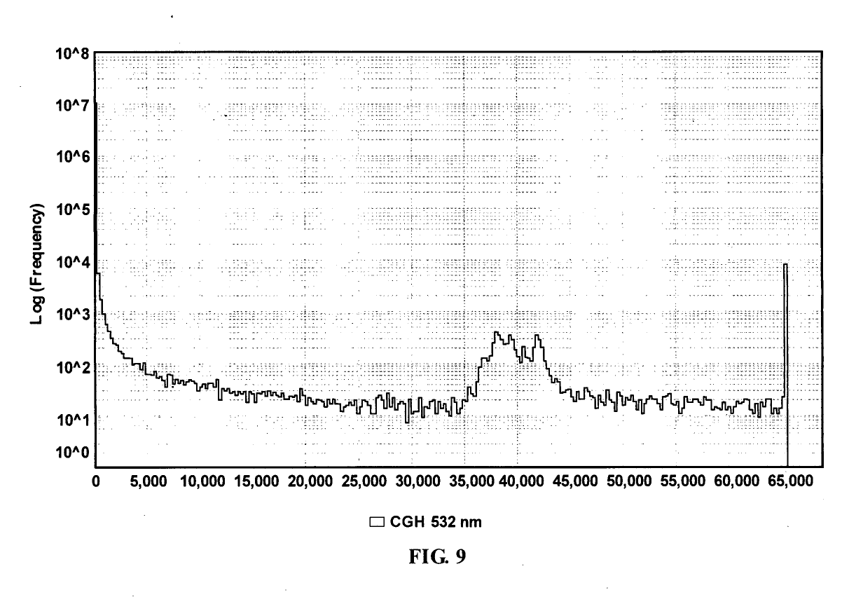

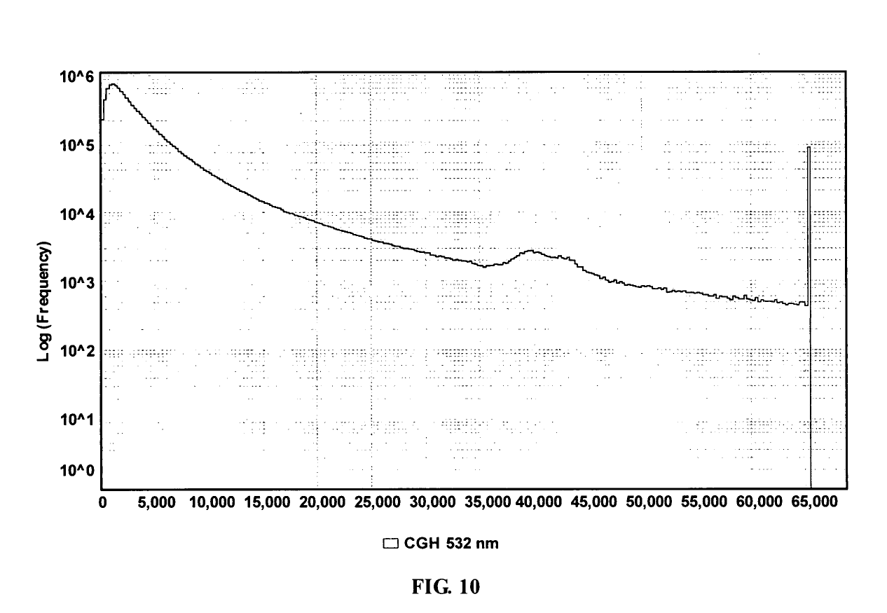

Signal to noise of the optical measurements detecting DNA probe features was superior in the ITO-coated hydroxy-alkylphosphonate coated slides compared with the silane functionalized slides, FIGS. 9 and 10. In particular, the histogram of FIG. 9 related to the ITO-coated hydroxy-alkylphosphonate shows a quick drop of the background while the features of interest are measurable in the most prominent family of peaks. In particular, in the illustration of FIG. 9 the ITO/phosphonate surfaces show a population of probes that have a relative fluorescence between signals. More particularly, the ITO/phosphonate surfaces show a population of probes that have a relative fluorescence between 35,000 and 45,000 and then saturated at 65,000+. These signals correspond to fiducial markers, i.e. perfect complementary DNA sequences. Key observation is that there is a very low population of probes that bind with measurable fluorescence less the 30,000 resulting in an enhanced signal to noise for the signals related to actual hybridization.

On the other hand, the histogram of FIG. 10 related to the silane derivatives glass slide shows a high background signal relative to the feature signal. FIG. 10 shows a histogram taken from a silane-derivatives glass slide comprising microarrays were synthesized using MAS technology. This surface binds nonspecific intensely fluorescent features resulting in a diminution of the signals of interest, i.e., those in the vicinity of 30,000 to 45,000 relative fluorescence units. Here too the fiducial markers show stuated absorbance in the vicinity of 65,000+ relative fluorescence values.

This attribute will lead to greater sensitivity of detection and, because of greater chemical stability, to more reproducible microarray experimental synthesis, measurement and same slide (chip) re-use.

The examples set forth above are provided to give those of ordinary skill in the art a complete disclosure and description of how to make and use the embodiments of the devices, systems and methods of the disclosure, and are not intended to limit the scope of what the inventors regard as their disclosure. Modifications of the above-described modes for carrying out the disclosure that are obvious to persons of skill in the art are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

The entire disclosure of each document cited (including patents, patent applications, journal articles, abstracts, laboratory manuals, books, or other disclosures) in the Background, Summary, Detailed Description, and Examples is hereby incorporated herein by reference.

It is to be understood that the disclosures are not limited to particular compositions or biological systems, which can, of course, vary. It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

Although any methods and materials similar or equivalent to those described herein can be used in the practice for testing of the products, methods and system of the present disclosure, exemplary appropriate materials and methods are described herein.

A number of embodiments of the disclosure have been described. Nevertheless, it will be understood that various modifications may be made without departing from the spirit and scope of the present disclosure. Accordingly, other embodiments are within the scope of the following claims.

What is claimed is:

1. A functionalized platform comprising
a substrate, and
a metal oxide layer,
wherein
the substrate is coated with the metal oxide layer and the metal oxide layer attaches an alkyl phosphonate compound presenting an alkyl phosphonate functional group,
the platform is configured to be associated, during operation, with a polymer array, and
the polymer array is configured for detection of a target attached to a polymer on the polymer array, through an optically detectable label attached to the target.

2. The functionalized platform of claim 1, wherein the alkyl phosphonate compound comprises at least one unit of formula
XR₁—PO(OR₂R₃)₂ (I)
wherein
R₁ is an alkyl group, R₂R₃ are H; and
X is the alkyl phosphonate functional group.

3. The functionalized platform of claim 2, wherein R₁ is a C₁-C₅ alkyl group, or a C₁₀-C₂₀ alkyl group.

4. The functionalized platform of claim 2, wherein R₁ is a C₁₁ alkyl group.

5. The functionalized platform of claim 2, wherein X is a hydroxyl, a carboxyl group, an amino group, a phosphoric acid group, or an epoxy group.

6. The functionalized platform of claim 1, wherein the metal oxide is InTiO.

7. The platform of claim 6, wherein InTiO comprises about 90% In₂O₃ and about 10% SnO₂ by weight.

8. The functionalized platform of claim 1, wherein the substrate is glass, quartz, silica or plastic.

9. A polymer array configured to allow detection of a target attached to the polymer through an optically detectable label attached to the target, the polymer array comprising
a polymer attached to a platform,
wherein the platform is the functionalized platform of claim 1 and the polymer is attached to the alkyl phosphonate functional group of the functionalized platform of claim 1.

10. The polymer array of claim 9, wherein the polymer is a polynucleotide or a polypeptide.

11. The polymer array of claim 9, wherein the polymer is DNA.

12. The polymer array of claim 9, wherein the polymer is spotted on the platform.

13. A bio-chip comprising the polymer array of claim 9.

14. A system for optical detection of a target, the system comprising
the polymer array of claim 9, and
the optically detectable label of claim 9.

15. The system of claim 14, wherein the optically detectable label is attached to a capture agent.

16. The system of claim 15, wherein the capture agent is an antibody.

17. The system of claim 14, wherein the optically detectable label is a fluorescent compound.

18. The system of claim 14, wherein the polymer array is comprised in a biochip.

19. A method to provide a polymer array, comprising:
providing the functionalized platform of claim 1; and
attaching a polymer to the alkyl phosphonate functional group of the functionalized platform, thus providing the polymer array.

20. The method of claim 19, wherein providing the platform is performed by
providing a substrate;
providing a metal oxide;
coating the substrate with the metal oxide thus forming a metal oxide layer on the substrate; and
attaching to the metal oxide layer an alkyl phosphonate comprising an alkyl phosphonate functional group, to provide a phosphonate metal oxide layer presenting the alkyl phosphonate functional group.

21. The method of claim 19, wherein attaching the polymer to the alkyl phosphonate functional group is performed by
providing a pre-synthesized polymer capable of binding the alkyl phosphonate functional group, and
binding the polymer to the alkyl phosphonate functional group.

22. The method of claim 19, wherein attaching a polymer to the alkyl phosphonate functional group is performed by
providing monomers composing the polymer, at least one of the monomers presenting a monomer functional group capable of binding the alkyl phosphonate functional group of the functionalized platform; and
contacting the monomers with the functionalized platform for a time and under conditions to allow synthesis of the polymer on the platform.
